(19) United States
(12) Patent Application Publication
(10) Pub. No.: US 2019/0233013 A1
(43) Pub. Date: Aug. 1, 2019

(54) VEHICLE BODY REAR STRUCTURE

(71) Applicant: HONDA MOTOR CO., LTD., Tokyo (JP)

(72) Inventors: Hideki TAI, Wako-shi (JP); Junya HARADA, Wako-shi (JP); Yoshihiro KOBAYASHI, Wako-shi (JP); Takashi SASAMOTO, Tokyo (JP)

(21) Appl. No.: 16/247,144

(22) Filed: Jan. 14, 2019

(30) Foreign Application Priority Data
Jan. 30, 2018 (JP) 2018014018

(51) Int. Cl. B62D 21/15; B62D 25/08; B62D 25/20; B60K 1/04; B60R 19/02; B62D 25/10

(52) U.S. Cl. CPC B62D 21/152; B62D 25/087; B62D 25/2027; B62D 25/16; B60K 1/04; B60R 19/02; B62D 25/10; B62D 25/2036

(57) ABSTRACT

A vehicle body rear structure comprises a pair of closed cross section structures (85) extending from a rear panel to respective rear wheel houses. Each closed cross section structure is formed by a rear side frame (42) extending in a fore and aft direction of a vehicle body, a floor extension (52C) extending in an outboard direction from the rear side frame, a side panel (82) extending vertically from an outboard edge of the floor extension, and a connecting panel (84) located under the floor extension, and having an inboard end fixedly attached to the rear side frame and an outboard end fixedly attached to the side panel.

### TECHNICAL FIELD

The present invention relates to a vehicle body rear structure, and in particular, to a vehicle body rear structure reinforced against a rear impact of a rear end crash.

### BACKGROUND ART

A known vehicle body rear structure for a motor vehicle comprises a pair of rear side frames extending in the fore and aft direction along either side of a lower part of a vehicle body, a pair of roof side rails extending in the fore and aft direction along either side of an upper part of the vehicle body, a rear panel extending laterally in a rear end part of the vehicle body, and joined to the upper sides of the rear side frames, a rear bumper beam joined to the rear side of the rear panel, and a pair of gutter members each having a lower end joined to the rear panel and an upper end joined to the corresponding roof side rail. The load acting on the rear bumper beam at the time of a rear end crash is transmitted to the rear side frames and the gutter members. See WO2011/027638A1, for instance.

Another known vehicle body rear structure comprises a pair of roof side rails extending in the fore and aft direction along either side of an upper part of the vehicle body, a rear panel extending laterally in a rear end part of the vehicle body, a pair of rear pillar extensions each having a lower end connected to a corresponding end of the rear panel and an upper end connected to the corresponding roof side frame, and a pair of gutter members each having a lower end connected to a part of the rear panel located more inboard than the corresponding rear pillar extension and an upper end connected to an intermediate part of the corresponding rear pillar extension. The load acting on the rear panel is transmitted to the roof side rails via the rear pillar extensions and the gutter members. See JP2014-46813A, for instance.

In the vehicle body design, it is desirable to limit a deformation stroke of the rear part of the vehicle body in the fore and aft direction at the time of a rear end crash. In particular, in a hybrid or electric vehicle carrying a relatively large battery pack in the rear end part of the vehicle body for powering the electric motor that propels the vehicle, the battery pack is required to be protected against a rear end crash. For this purpose, the vehicle body is desired to be designed in such a manner that the impact load of a rear end crash is efficiently transmitted to a more front part of the vehicle body, and the deformation stroke of the rear end part of the vehicle in the fore and aft direction is controlled within a prescribed limit.

### SUMMARY OF THE INVENTION

In view of such a problem of the prior art, a primary object of the present invention is to provide a vehicle body rear structure which allows the impact load of a rear end crash to be efficiently transmitted to a more front part of the vehicle body, and the deformation stroke of the rear end part of the vehicle in the fore and aft direction to be controlled within a prescribed limit.

To achieve such an object, one embodiment of the present invention provides a vehicle body rear structure, comprising: a pair of rear side frames (42) extending in a fore and aft direction of a vehicle body in a laterally spaced apart relationship; a rear panel (26) extending laterally and substantially vertically, and fixedly attached to rear end parts of the rear side frames (42); a pair of rear wheel houses (58) fixedly attached to outboard sides of the respective rear side frames (42); a rear floor panel (52) including a main part (52A) fixedly attached to upper sides of the rear side frames (42) and extending between the rear side frames (42), and a pair of floor extensions (52C) extending in an outboard direction from the respective rear side frames (42); a pair of side panels (82) each fixedly attached to and extending substantially vertically along an outboard end of the corresponding floor extension, and having a front end connected to a rear end part of the corresponding rear wheel house; and a pair of connecting panels (84) each located under the corresponding floor extension, and having an inboard end fixedly attached to the corresponding rear side frame and an outboard end fixedly attached to the corresponding side panel; wherein the rear side frame (42), the side panel (82), the floor extension (52C) and the connecting panel (84) on each side of the vehicle body jointly define a closed cross section structure (85) extending from the rear panel to the rear wheel house.

Thereby, a rear impact load applied to the rear panel at the time of a rear end crash is transmitted to the rear wheel houses via the closed cross section structures each defined by the rear side frame, the side panel, the floor extension and the connecting panel on the corresponding side of the vehicle body so that the deformation of the vehicle body rear structure can be favorably controlled.

In this vehicle body rear structure, preferably, rear edges of the rear floor panel (52) and the connecting panels (84) are connected to the rear panel (26), and front edges of the floor extensions (52C) and the connecting panels (84) are connected to the respective rear wheel houses (58).

Thereby, a rear impact load can be favorably transmitted from the rear panel (26) to the rear wheel houses (58) so that the deformation of the vehicle body rear structure can be favorably controlled.

Preferably, an interior of each closed cross section structure is provided with a bulkhead member (88).

Thereby, the stiffness of each closed cross section structure against torsional deformation can be improved so that the deformation of the vehicle body rear structure can be favorably controlled. Preferably, the bulkhead member is attached to the rear side frame (42), the rear floor panel (52) and the connecting panel (84) to maximize this effect.

In this vehicle body rear structure, preferably, the bulkhead member comprises a plurality of bulkhead members arranged along a length of each closed cross section structure, and the rear floor panel defines a battery pack receiving part between the rear side frames, at least one of the bulkhead members being positioned behind a rear end of the battery pack receiving part.

Thereby, the deformation of the battery pack receiving part at the time of a rear end collision can be avoided.

This vehicle body rear structure may further comprise a rear bumper beam (50) attached to a rear side of the rear panel and extending laterally, the rear bumper beam including a pair of overlapping portions (50A) overlapping at least partly with the respective closed cross section structures in rear view.

Thereby, the rear impact load at the time of an offset rear end crash can be efficiently transmitted to a more front part of the vehicle body so that the deformation of the rear end part of the vehicle body at the time of the crash can be minimized.

In this vehicle body rear structure, preferably, the connecting panels are each provided with a bead (86) extending in the fore and aft direction.

Thereby, the bending stiffness of the connecting panels (84) can be improved without increasing the thickness of the connecting panels (84) so that the connecting panel (84) prevented from deforming excessively at the time of a rear end crash.

According to a preferred embodiment of the present invention, this vehicle body rear structure further comprises a trunk lid (30) hinged to a rear end part of the vehicle body so as to selectively close an opening (28) defined in the rear end part of the vehicle body, a beam member (90) extending laterally and fixedly attached to an inner side of a substantially vertically extending part (30B) of the trunk lid, a pair of restraining members (92) attached to rear ends of the respective closed cross section structures so as to oppose the beam member, the restraining members being configured to abut the beam member when the trunk lid has deformed in a forward direction as a result of a rear end crash.

Thereby, the trunk lid fitted with the beam member can contribute to a favorable distribution of the impact load to a more front part of the vehicle body at the time of a rear end crash. In particular, the restraining members may each be provided with a concave cutout (92A) in a rear end thereof opposing the beam member and configured to receive the beam member in case of a rear end crash so that this effect may be maximized.

Thus, the present invention provides a vehicle body rear structure which allows the impact load of a rear end crash to be efficiently transmitted to a more front part of the vehicle body, and the deformation stroke of the rear end part of the vehicle in the fore and aft direction to be controlled within a prescribed limit.

### BRIEF DESCRIPTION OF THE DRAWING(S)

FIG. 1 is a perspective rear view of a rear end part of a vehicle body according to an embodiment of the present invention;

FIG. 2 is a side view of the rear end part of the vehicle body;

FIG. 3 is a bottom view of the rear end part of the vehicle body;

FIG. 4 is a perspective sectional view of the rear end part of the vehicle body taken along a horizontal plane;

FIG. 5 is a fragmentary perspective view of the rear end part of the vehicle body partly in section;

FIG. 6 is a perspective sectional view of the rear end part of the vehicle body taken along a plane orthogonal to a fore and aft direction;

FIG. 7 is a fragmentary perspective view of an outboard part of the rear end part of the vehicle body; and

FIG. 8 is an enlarged fragmentary section view of the rear end part of the vehicle body taken along a plane orthogonal to the fore and aft direction.

### DESCRIPTION OF THE PREFERRED EMBODIMENT(S)

A preferred embodiment of the present invention is described in the following with reference to the appended drawings.

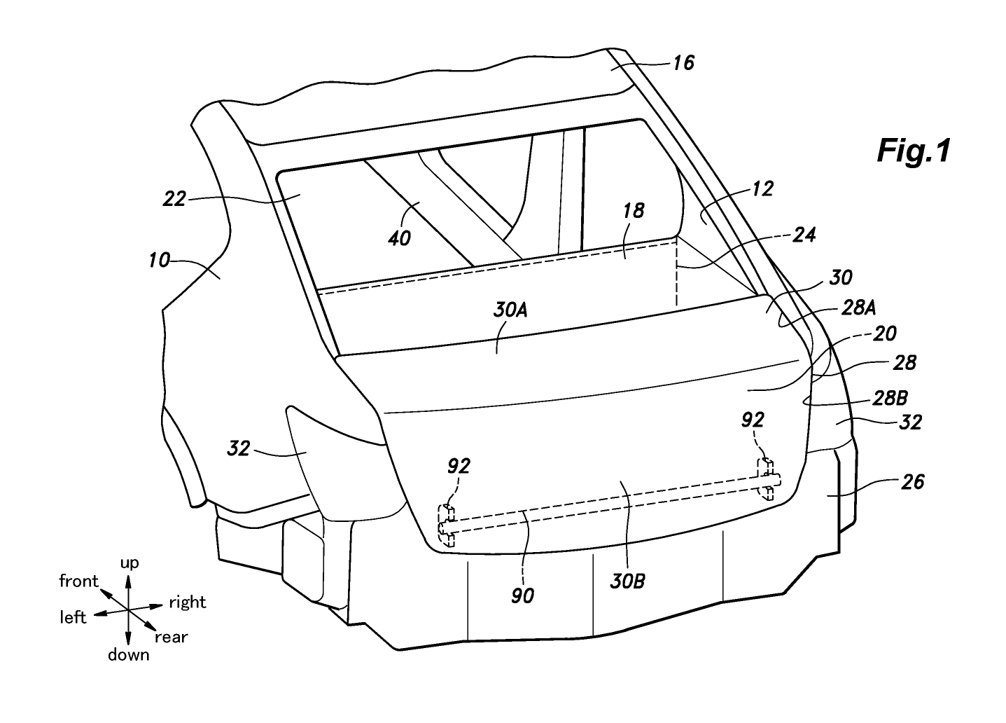

As shown in FIG. 1, a vehicle body rear structure according to the present embodiment includes a pair of side outer panels 10 extending along either side of the vehicle body, a pair of side inner panels 12 extending along inner sides of the respective side outer panels 10, a roof panel 16 extending laterally between the upper edges of the side outer panels 10 and the side inner panels 12, a rear parcel shelf 18 extending horizontally between the side inner panels 12, a rear bulkhead 24 extending downward from the rear parcel shelf 18 to separate a trunk room 20 from a passenger compartment 22, a rear panel (rear end panel) 26 extending laterally and substantially vertically between rear edges of the side inner panels 12, and a trunk lid 30 attached to the rear parcel shelf 18 via a hinge (not shown) to selectively open an opening 28 defined in a rear end part of the vehicle body to afford access to the trunk room 20 from outside of the vehicle. A pair of rear combination lights 32 are attached to rear end parts of the respective side outer panels 10.

The opening 28 of the trunk room 20 includes an upper opening part 28A defined by substantially horizontal side edges, and a rear opening part 28B defined by substantially vertical side edges. The trunk lid 30 includes a horizontal portion 30A extending substantially horizontally so as to correspond to the upper opening part 28A, and a vertical portion 30B extending substantially vertically so as to correspond to the rear opening part 28B.

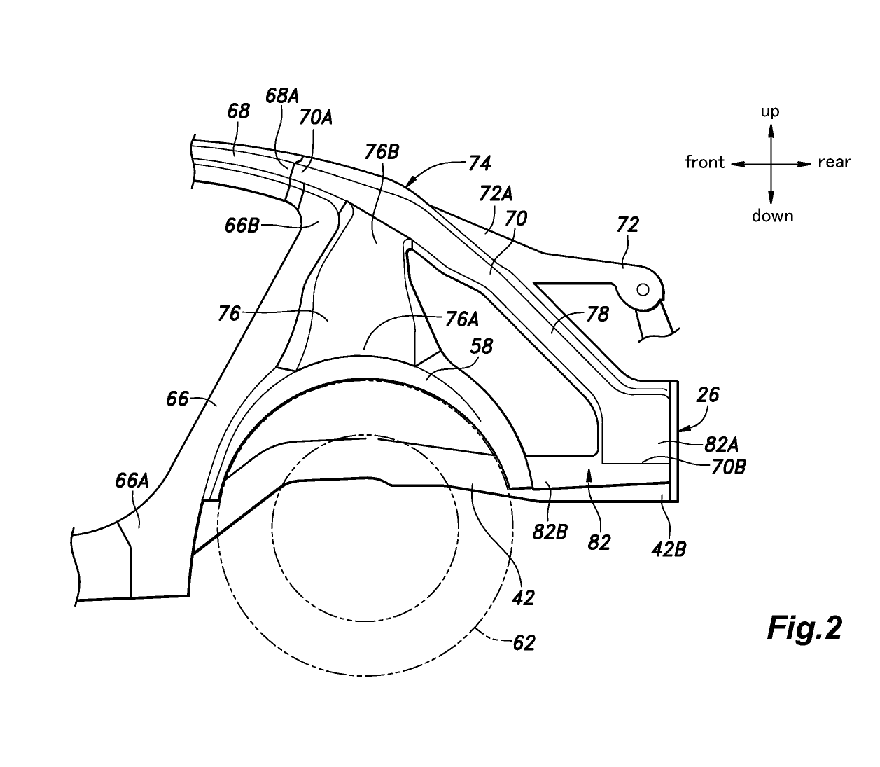

As shown in FIGS. 2 to 8, the rear structure of the vehicle body according to the present embodiment includes a pair of side sills 40 provided on either side of the vehicle body and extending in the fore and aft direction, a pair of rear side frames (rear floor frames) 42 having front ends 42A connected to rear ends 40A of the corresponding side sills 40 and extending along either side of the trunk room 20, a rear floor middle cross member 44 extending laterally between middle parts of the rear side frames 42, a rear floor end cross member 46 extending laterally between rear end parts of the rear side frames 42, and a connecting frame 48 extending in the fore and aft direction between a middle part of the rear floor end cross member 46 and a corresponding lower middle part of the rear panel 26. The side sills 40, the rear side frames 42, the rear floor middle cross member 44, and the rear floor end cross member 46 are each formed of a steel channel member having an open side facing upward, and are joined to a rear floor panel 52, which will be described later, to define a closed cross section.

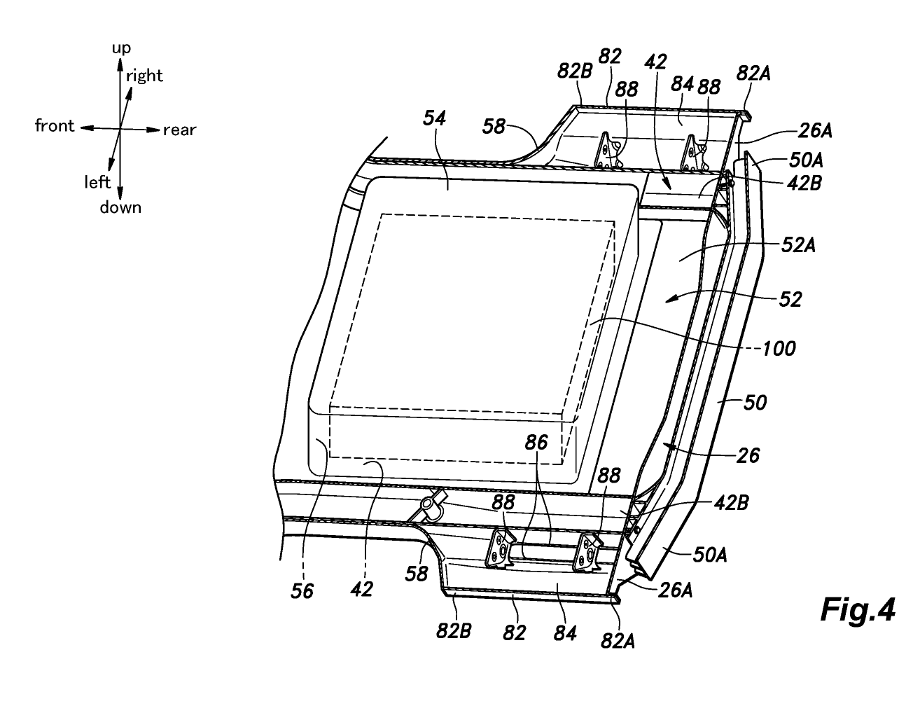

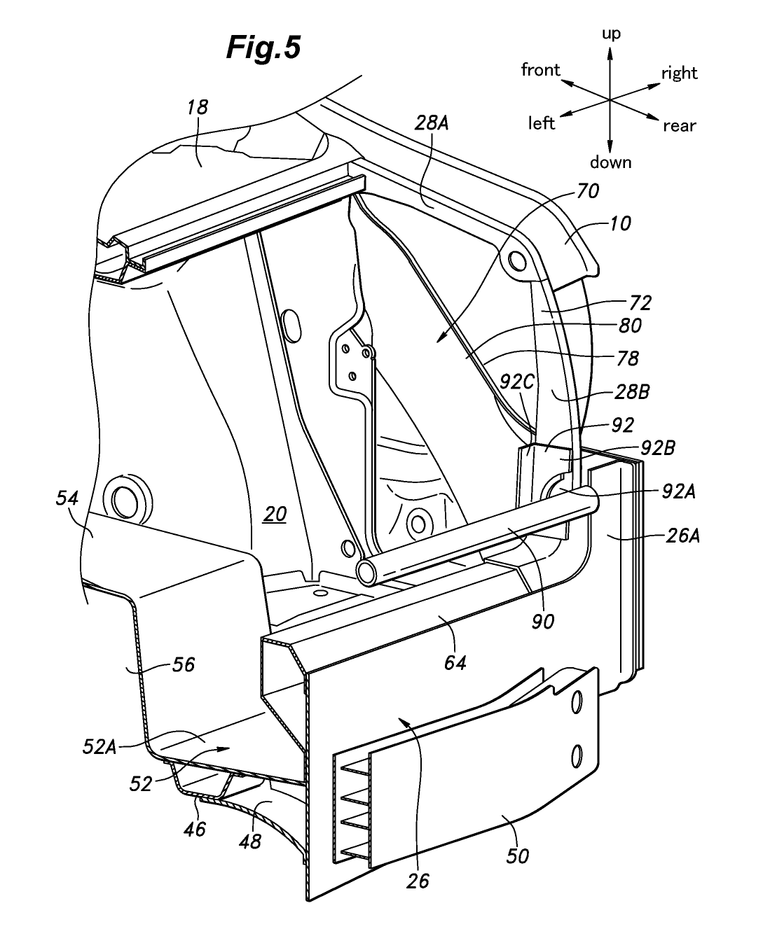

The rear ends 42B of the rear side frames 42 are connected to the rear panel 26. More specifically, the rear panel 26 is connected to the rear ends 42B of the left and right rear side frames 42, and extends laterally. A rear bumper beam 50 (see FIGS. 4 and 5) extending laterally is attached to the rear side of the rear panel 26.

The rear side frames 42 are each provided with a pair of flanges on either side of the upper end thereof. The rear floor panel 52 is attached to the upper sides of these flanges of the rear side frames 42. More specifically, the rear floor panel 52 includes a main panel 52A joined to the upper sides of the inboard flanges of the rear side frames 42, and extending between the inboard flanges of the two rear side frames 42, a pair of side panels 52B each attached to the inboard flange (via the corresponding edge part of the main panel 52A) and the outboard flange of the corresponding rear side frame 42 so as to close the upper open end of the rear side frame 42, and a pair of floor extension panels (floor extension portion) 52C attached to the outboard flange of the corresponding rear side frame 42 (via the corresponding side panel 52B) and extending horizontally in the outboard direction.

The main panel 52A is provided with a bulging part 54 protruding upward so as to define a trapezoidal profile in both front view and side view (see FIGS. 4 and 5). The bulging part 54 defines a battery pack receiving part 56 (see FIG. 5) to receive a battery pack 100 therein for powering the electric motor of the vehicle (which consists of a hybrid vehicle or an electric vehicle).

The left and right rear wheel houses 58 are attached to the outboard sides of the rear side frames 42, respectively. Left and right rear fenders 60 are joined to the outboard sides of the rear wheel houses 58, respectively. The left and right rear wheels 62 of the vehicle are covered by the respective rear wheel houses 58 and the respective rear fenders 60.

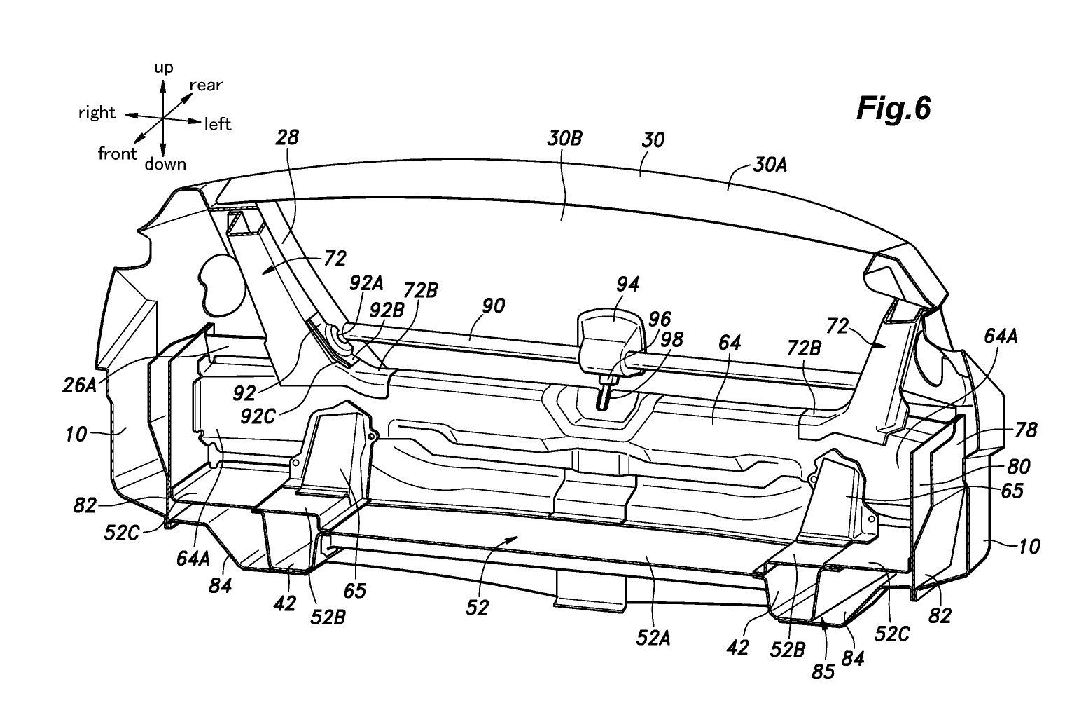

As shown in FIGS. 5 and 6, the rear structure of the vehicle body according to the present embodiment further includes a rear panel cross member 64 attached to the front side of the rear panel 26 (facing the interior of the trunk room 20) and extending laterally, a pair of rear pillar members (C pillar) 66 (see FIG. 2) extending upward from front end parts of the respective rear side frames 42, a pair of roof side rails 68 (see FIG. 2) extending in the fore and aft direction on either side of an upper part of the vehicle body, a pair of rear pillar extension members (quarter pillars) 70 each having a front end (upper end) 70A connected to the rear end 68A of the corresponding roof side rail 68 and extending linearly downward and rearward from the front end 70A thereof, and a pair of gutter frames 72 each having an upper end 72A (see FIG. 2) connected to an intermediate part of the corresponding rear pillar extension member 70 and a lower end 72B (see FIG. 6) connected to an upper part of the corresponding side end part of the rear panel cross member 64. The rear pillar extension members 70 and the gutter frames 72 are collectively referred to as a rear upper frame 74.

As shown in FIGS. 5 and 6, the rear panel cross member 64 is provided with a channel cross section having an open side facing rearward, and is attached to the rear panel 26 so as to define a closed cross section in cooperation with the rear panel 26. The rear panel cross member 64 and the rear panel 26 are provided with side extensions 26A and 64A that extend in the outboard direction beyond the respective rear side frames 42.

As shown in FIG. 6, the rear end parts of the rear side frames 42 are each connected to the rear panel cross member 64 via a brace member 65 extending in the vertical direction. The brace members 65 are each provided with a channel cross section having an open side facing both rearward and downward, and is attached to the side panel 52B of the rear floor panel 52 and the rear panel cross member 64 at the open side thereof so as to define a closed cross section in cooperation with the side panel 52B of the rear floor panel 52 and the rear panel cross member 64. The brace members 65 prevent the bending deformation (leaning deformation) of the rear panel 26 and the rear panel cross member 64 in the fore and aft direction.

As shown in FIG. 2, each rear pillar member 66 has a lower end 66A joined to the corresponding rear side frame 42 and an upper end 66B joined to a part of the corresponding rear pillar extension member 70 adjacent to the upper end thereof. The rear side of an upper part of each rear pillar member 66 is joined to a front side of a wheel house upper member 76 having a lower end 76A joined to an upper part of the corresponding wheel house 58 and an upper end 76B joined to the corresponding rear pillar extension member 70.

As shown in FIG. 6, the gutter frames 72 each include a part extending along the corresponding side edge of the opening 28 of the trunk room 20, and define the rear corners of the opening 28 of the trunk room 20 in cooperation with the rear panel cross member 64. As shown in FIG. 5, each gutter frame 72 includes a part that has a channel shaped cross section, and defines a closed cross section in cooperation with the corresponding side outer panel 10. Therefore, the gutter frames 72 are provided with a high mechanical strength and a high mechanical stiffness so that the gutter frames 72 are prevented from deforming at the time of a rear end crash, and can transmit the impact load of a rear end crash to a more front part of the vehicle body.

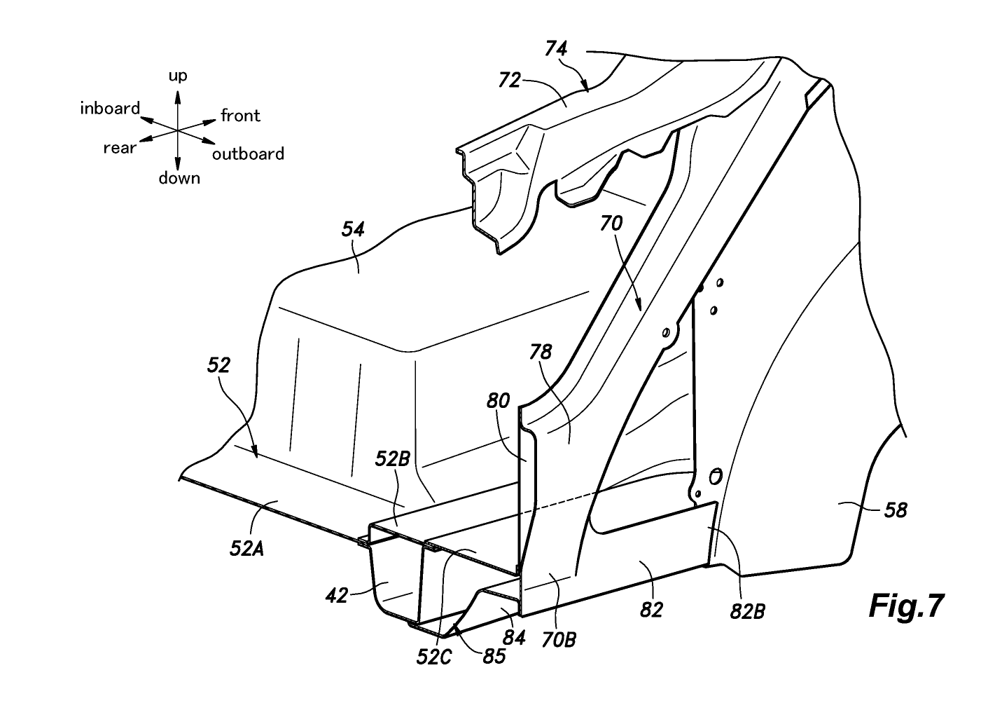

As shown in FIG. 7, each rear pillar extension member 70 includes a channel member 78 and a flat plate shaped lid member 80 joined to the channel member 78 to jointly define a closed cross section. This improves the mechanical strength and mechanical stiffness of the rear pillar extension members 70 so that the rear pillar extension members 70 are highly resistant to deformation which could be otherwise caused by the rear impact load of a rear end crash, and can transmit the impact load to a more front part of the vehicle in an efficient manner.

The rear end (lower end) 70B of each rear pillar extension member 70 is located so as to offset from the lower end 72B of the corresponding gutter frame 72 in the outboard direction, and is joined, at the lid member 80 thereof to the corresponding side extension 26A of the rear panel 26, the outboard end of the corresponding side extension 64A of the cross member 64 and the outboard end of the corresponding floor extension panel 52C.

The lower end of the channel member 78 of each rear pillar extension member 70 extends in the fore and aft direction along the outboard edge of the floor extension panel 52C as shown in FIGS. 2 to 4 and 7, thereby forming a part of a side panel 82 extending substantially vertically. Each side panel 82 includes a rear end 82A joined to the corresponding side extension 26A of the rear panel 26 and a front end 82B joined to a rear part of the corresponding rear wheel house 58, and is joined to the outboard end of the corresponding floor extension panel 52C via the lid member 80 of the corresponding rear pillar extension member 70.

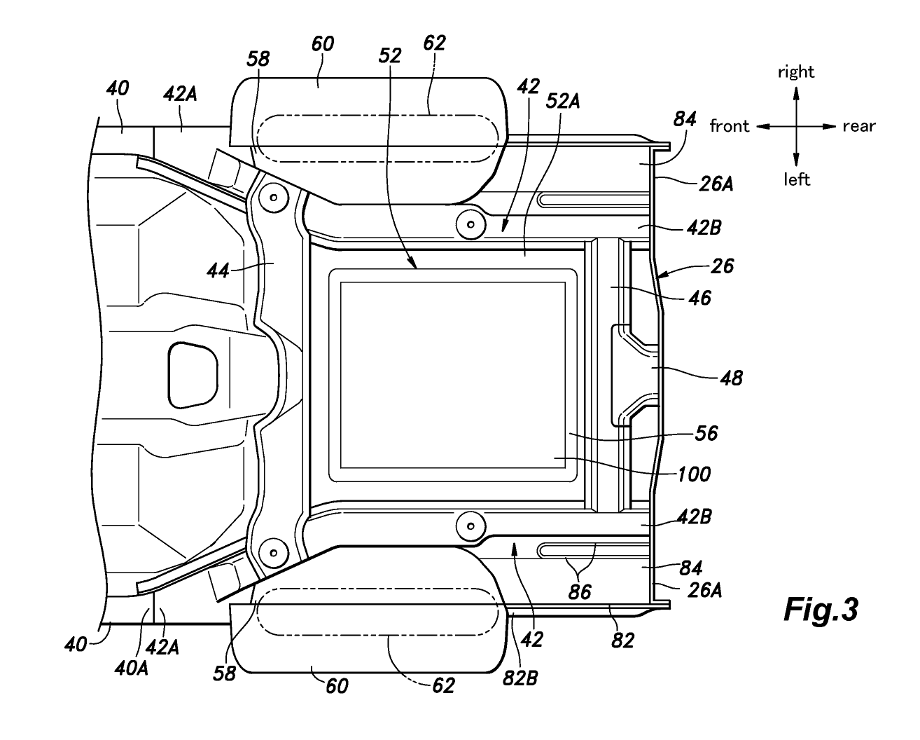

As shown in FIGS. 6 to 8, a connecting panel 84 forming an outrigger member is attached to the lower side of each floor extension panel 52C. As shown in FIGS. 3 and 4, each connecting panel 84 extends between the rear panel 26 and the corresponding rear wheel house 58, and has a rear end joined to the corresponding side extension 26A of the rear panel 26, a front end joined to a rear part of the corresponding rear wheel house 58, an inboard side joined to a bottom part of the corresponding rear side frame 42, and an outboard side joined to the corresponding side panel 82.

As shown in FIGS. 3, 4, and 8, beads 86 extending in the fore and aft direction are formed in the connecting panels 84 so that the bending stiffness of the connecting panels 84 is ensured without increasing the thickness of the connecting panels 84, and the connecting panels 84 are prevented from deforming excessively under the impact of a rear end crash.

As shown in FIGS. 6 to 8, each connecting panel 84 defines a closed cross section structure 85 extending continuously from the rear panel 26 to the corresponding rear wheel house 58 in cooperation with the rear side frame 42, the side panel 82, and the floor extension panel 52C on the corresponding side of the rear part of the vehicle body. In other words, on each side of the rear part of the vehicle body, the rear side frame 42, the connecting panel 84, and the side panel 82 jointly define the closed cross section structure 85 that extends continuously from the rear panel 26 to the wheel house 58.

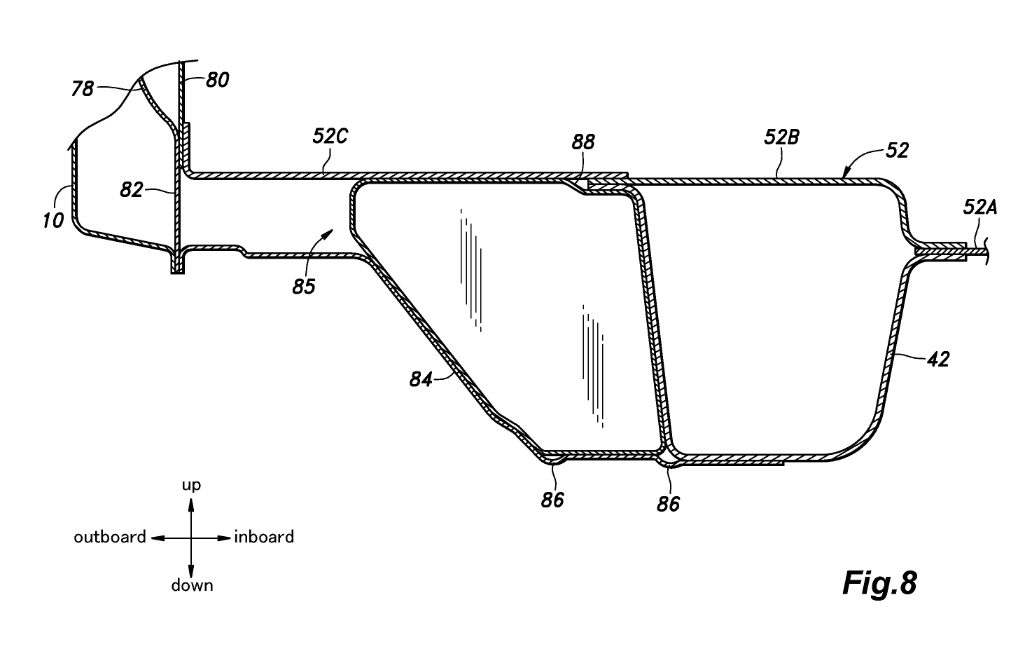

As shown in FIGS. 4 and 8, the closed cross section structures 85 are internally provided with a plurality of bulkhead members 88 that are arranged along the length thereof in a mutually spaced apart relationship and attached to the rear side frames 42, the floor extension panels 52C and the connecting panels 84. Thereby, the bending stiffness of the closed cross section structures 85 is maximized.

At least one of the bulkhead members 88 in each closed cross section structure 85 is located behind the rear end of the battery pack receiving part 56.

As shown in FIG. 4, the rear bumper beam 50 includes a pair of overlapping portions 50A overlapping with either lateral end of the closed cross section structure 85 in rear view.

As shown in FIGS. 1, 5 and 6, a beam member 90 made of a pipe member extending laterally is fixedly attached to the side of the vertical portion 30B of the trunk lid 30 facing the interior of the trunk room 20 at the two lateral end parts thereof.

A pair of restraining members 92 are provided on lower end parts of the respective gutter frames 72. Each restraining member 92 includes a main part 92B provided with a concave cutout 92A facing rearward, and a flange 92C bent from the front edge of the main part in the inboard direction to be fixedly secured to the corresponding gutter frame 72. The restraining members 92 are positioned such that the concave cutouts 92A oppose the respective lateral ends of the beam member 90 when the trunk lid 30 is closed. The concave cutouts 92A are configured and dimensioned so as to abut the beam member 90 when the trunk lid 30 along with the beam member 90 is pushed forward at the time of a rear end crash. In the illustrated embodiment, the concave cutouts 92A are configured and dimensioned so as to closely or otherwise receive the beam member 90 when the trunk lid 30 along with the beam member 90 is pushed forward at the time of a rear end crash. The flange 92C of each restraining member 92 allows the restraining member 92 to be fixedly secured to the corresponding gutter frame 72 in a highly secure manner.

As shown in FIG. 6, a striker housing 94 is fixedly attached to a laterally middle point of the vertical portion 30B of the trunk lid 30. The striker housing 94 supports a striker 96 that cooperates with a latch 98 which is attached to a laterally middle point of the rear panel cross member 64.

The beam member 90 is passed laterally through the striker housing 94 so that a laterally middle point of the beam member 90 is supported by the trunk lid 30 via the striker housing 94.

According to the rear structure of the vehicle body discussed above, the impact load (rear crash load) of a rear end crash is transmitted from the rear panel 26 and the rear panel cross member 64 to the rear pillar extension members 70, and thence to the corresponding roof side rails 68. The rear panel 26 and the rear panel cross member 64 are joined to the rear pillar extension members 70 in parts thereof which consist of closed cross sections so that the mechanical strength and stiffness of the joints at which the rear pillar extension members 70 are joined to the rear panel 26 and the rear panel cross member 64 can be maximized. Therefore, the rear end part of vehicle body can be made highly resistant against deformation at the time of a rear end crash, and the impact load of a rear end crash can be transmitted from the rear pillar extension members 70 to the roof side rails 68 in an efficient manner. As a result, the rear end part of the vehicle body becomes highly resistant to deformation so that the battery pack 100 received in the battery pack receiving part 56 is favorably protected from the rear impact load of a rear end crash.

The rear impact load is also transmitted from the rear panel cross member 64 to the gutter frames 72. Therefore, the rear impact load transmitted from the rear panel cross member 64 to the roof side rails 68 is partly diverted to the roof side rails 68. As a result, the rear end part of the vehicle body is favorably protected from deformation so that the rear impact load is prevented from being transmitted to the battery pack 100 received in the battery pack receiving part 56, and the battery pack 100 is thereby protected from the rear impact load.

The rear impact load transmitted to the gutter frames 72 is also transmitted to the rear bulkhead 24 and the roof side rails 68 via the rear parcel shelf 18 so that the rear impact load can be widely distributed. The rear impact load is also transmitted to the rear side frames 42 and the rear wheel houses 58 so that the load which is otherwise applied to the rear pillar extension members 70 and the gutter frames 72 is favorably diverted. The rear impact load is also transmitted from the rear bumper beam 50 to the rear side frames 42. As a result, the rear end part of the vehicle body is less likely to be deformed, and the rear impact load is prevented from acting on the battery pack 100 received in the battery pack receiving part 56 so that the battery pack 100 is favorably protected from the rear impact load.

The rear impact load is transmitted from the rear bumper beam 50 to the rear side frames 42 so that the rear end part of the vehicle body is highly resistant to deformation. This also protects the battery pack 100 received in the battery pack receiving part 56 from the impact of a rear end crash.

Since the rear panel cross member 64 and the rear side frames 42 are connected to each other via the respective brace members 65, the connecting strength between the rear panel cross member 64 and the rear side frames 42 is improved, and the impact load is favorably transmitted from the rear panel cross member 64 to the rear side frames 42. This also protects the battery pack 100 received in the battery pack receiving part 56 from the impact load of a rear end crash.

The rear impact load is also transmitted from the rear bumper beam 50 and the rear panel 26 to the rear wheel houses 58 via the respective closed cross section structures 85. This further improves the capability of the rear end part of the vehicle body to resist deformation so that the battery pack 100 received in the battery pack receiving part 56 is protected from a rear end crash.

Even if the rear impact load is so great that the rear end part of the closed cross section structures 85 and the rear wheel houses 58 are deformed forward, this deformation is limited by the rear wheel houses 58 coming into contact with the respective rear wheels 62, and the rear impact load is transmitted to the rear side frames 42 and other parts via the rear wheels 62 and the suspension systems (not shown in the drawings) for the rear wheels 62. Therefore, even when the impact load is significant, the battery pack 100 received in the battery pack receiving part 56 is protected from the rear impact of a rear end crash.

Since the rear edges of the rear floor panel 52 and the connecting panels 84 are joined to the rear panel 26, and the front edges of the floor extension panels 52C and the connecting panels 84 are joined to the respective rear wheel houses 58, the rear impact load can be favorably transmitted from the rear panel 26 to the rear wheel houses 58. Therefore, the battery pack 100 is favorably protected from the rear impact of a rear end crash.

Since the bending stiffness of the connecting panels 84 each forming a part of the corresponding closed cross section structure 85 is increased by the beads 86, the bending stiffness of the closed cross section structures 85 is enhanced without increasing the weight of the vehicle body due to the presence of the connecting panels 84, and the battery pack 100 is favorably protected from the impact of a rear end crash.

The bulkhead members 88 provided in the closed cross section structures 85 improve the torsional stiffness and other mechanical properties of the closed cross section structures 85, and makes the closed cross section structures 85 highly resistant to deformation at the time of a rear end crash. In particular, the battery pack 100 received in the battery pack receiving part 56 is favorably protected from the impact of a rear end crash. Since one or some of the bulkhead members 88 are provided in the part of each closed cross section structure 85 located behind the rear end of the battery pack receiving part 56, the battery pack 100 is favorably protected from the rear impact load.

Since the rear bumper beam 50 includes the overlapping portions 50A overlapping with the closed cross section structures 85, at the time of an offset rear end crash, the overlapping portion 50A of the corresponding side comes into contact with the corresponding closed cross section structure 85 so that the closed cross section structure 85 supports the impact load of the offset rear end crash, and the deformation of the rear end part of the vehicle body is minimized. As a result, at the time of an offset rear end crash also, the battery pack 100 is favorably protected from the rear impact load of the offset rear end crash.

When the trunk lid 30 is displaced forward due to a rear end crash, the beam member 90 is displaced forward, and the two ends of the beam member 90 are engaged by the concave cutouts 92A of the restraining members 92 so that the beam member 90 is firmly restrained by the restraining members 92. As a result, the rear impact is transmitted from the beam member 90 to the rear upper frame 74 so that the trunk room 20 is prevented from deforming excessively owing to the rear impact load. As a result, even when the battery pack 100 is positioned in the trunk room 20 or in a front part of the trunk room 20, the rear impact load is prevented from being directly applied to the battery pack 100, and the battery pack 100 is favorably protected from the rear end crash.

Since the beam member 90 is provided on the vertical portion 30B of the trunk lid 30, the impact load caused by a rear end crash is received by the beam member 90, and thence transmitted to the rear upper frame 74 in a favorable manner.

Since the rear impact load caused by a rear end crash is also transmitted from the engagement portion between the striker 96 and the latch 98 to the rear panel cross member 64, the rear impact load is transmitted from the beam member 90 to the rear upper frame 74 at the middle point of the beam member 90 as well as the lateral end parts of the beam member 90. As a result, the rear impact load of a rear end crash is transmitted to a front part of the vehicle body in a widely distributed manner.

Since each restraining member 92 is provided with the flange 92C extending from the base end edge (front edge) of the main part 92B, the strength and stiffness of the restraining member 92 is increased so that the restraining member 92 is enabled to receive and support the beam member 90 in a reliable manner.

Although the present invention has been described in terms of a specific embodiment, the present invention is not limited by such an embodiment, but may be modified and substituted in various ways without departing from the spirit of the present invention. For instance, the present invention is applicable not only to sedan type vehicles but also to hatchback vehicles.

1. A vehicle body rear structure, comprising:
a pair of rear side frames extending in a fore and aft direction of a vehicle body in a laterally spaced apart relationship;
a rear panel extending laterally and substantially vertically, and fixedly attached to rear end parts of the rear side frames;
a pair of rear wheel houses fixedly attached to outboard sides of the respective rear side frames;
a rear floor panel including a main part fixedly attached to upper sides of the rear side frames and extending between the rear side frames, and a pair of floor extensions extending in an outboard direction from the respective rear side frames;
a pair of side panels each fixedly attached to and extending substantially vertically along an outboard end of the corresponding floor extension, and having a front end connected to a rear end part of the corresponding rear wheel house; and
a pair of connecting panels each located under the corresponding floor extension, and having an inboard end fixedly attached to the corresponding rear side frame and an outboard end fixedly attached to the corresponding side panel;
wherein the rear side frame, the side panel, the floor extension and the connecting panel on each side of the vehicle body jointly define a closed cross section structure extending from the rear panel to the rear wheel house.

2. The vehicle body rear structure according to claim 1, wherein rear edges of the rear floor panel and the connecting panels are connected to the rear panel, and front edges of the floor extensions and the connecting panels are connected to the respective rear wheel houses.

3. The vehicle body rear structure according to claim 1, wherein an interior of each closed cross section structure is provided with a bulkhead member.

4. The vehicle body rear structure according to claim 3, wherein the bulkhead member is attached to the rear side frame, the rear floor panel and the connecting panel.

5. The vehicle body rear structure according to claim 4, wherein the bulkhead member comprises a plurality of bulkhead members arranged along a length of each closed cross section structure, and the rear floor panel defines a battery pack receiving part between the rear side frames, at least one of the bulkhead members being positioned behind a rear end of the battery pack receiving part.

6. The vehicle body rear structure according to claim 1, further comprising a rear bumper beam attached to a rear side of the rear panel and extending laterally, the rear bumper beam including a pair of overlapping portions overlapping at least partly with the respective closed cross section structures in rear view.

7. The vehicle body rear structure according to claim 1, wherein the connecting panels are each provided with a bead extending in the fore and aft direction.

8. The vehicle body rear structure according to claim 1, further comprising a trunk lid hinged to a rear end part of the vehicle body so as to selectively close an opening defined in the rear end part of the vehicle body, a beam member extending laterally and fixedly attached to an inner side of a substantially vertically extending part of the trunk lid, a pair of restraining members attached to rear ends of the respective closed cross section structures so as to oppose the beam member, the restraining members being configured to abut the beam member when the trunk lid has deformed in a forward direction as a result of a rear end crash.

9. The vehicle body rear structure according to claim 8, wherein each restraining member is provided with a concave cutout in a rear end thereof opposing the beam member and configured to receive the beam member in case of a rear end crash.
